(19) United States
(12) Patent Application Publication
(10) Pub. No.: US 2016/0255995 A1
(43) Pub. Date: Sep. 8, 2016

(54) Stove-top barbecue

(71) Applicant: Laleh Mirzaei, Fullerton, CA (US)

(72) Inventor: Laleh Mirzaei, Fullerton, CA (US)

(21) Appl. No.: 15/060,591

(22) Filed: Mar. 3, 2016

Related U.S. Application Data
(60) Provisional application No. 62/128,496, filed on Mar. 4, 2015.

(51) Int. Cl. A47J 37/06

(52) U.S. Cl. CPC A47J 37/067; A23L 1/0128; A23V 2002/00

(57) ABSTRACT

A stove-top barbecue includes a base supporting a grill and a cover. The base and grill include aligned central openings to permit heating by flames from a burner on a stove. The base further includes a concave tray surrounding the opening to retain fluids.

### CROSS-REFERENCE TO RELATED APPLICATIONS

This application claims priority to provisional patent application Ser. No. 62/128496 filed Mar. 4, 2015, the disclosure of which is incorporated by reference for all purposes.

### BACKGROUND OF THE INVENTION

### Field of the Invention

This invention is in the field of cooking appliances, more particularly stove-top cooking.

### Barbecue

Barbecuing and in particular flame grilling is generally an outdoor activity, but this is not always practical in inclement weather or in an urban area. Barbecue aficionados would like access to barbecued food even if traditional methods are not possible. There is therefore a need for devices and methods to prepare barbecued food that is not dependent on access to outdoor cooking.

Indoor barbecuing is subject to constraints because incompletely burned fuels, such as charcoal, can produce toxic gases. Barbecuing can also produce excessive smoke and odors that are difficult to handle indoors. There is thus also a need for barbecue devices and methods that do not generate toxic gases or excessive smoke.

Although indoor grills exist in the art, these rely to a large measure on heat transfer from hot surfaces to cook food in contact with those surfaces. However the action of flame and of heated gases, including the effects of rapid convection of such heated gases can produce a more flavorful food product wherein all food surfaces may be cooked at a high rate. There is thus a need for an indoor barbecue that applies heated air or gases to all surfaces of food being cooked.

### BRIEF SUMMARY OF THE INVENTION

In some embodiments, the invention includes a stove-top barbecue that includes a base with a central aperture, a concave tray surrounding the aperture, and a peripheral recess. A cover may be configured to mount in the recess and a grill sized to fit between the base and the cover. The grill includes an open cooking surface. The central aperture may be sized to accept a burner element of a gas stove.

The grill may also include a central hole positioned such that, when the grill is disposed on the base, the hole aligns with the aperture. In some embodiments one or more of the cover and the base includes an attachment for a removable handle.

In some embodiments, a stove-top barbecue includes a base supporting a grill and a cover. The base includes an aperture that penetrates the base and an annular tray that surrounds the aperture. The tray may be configured to retain a fluid. The base may further include an inner wall surrounding the aperture and a peripheral outer wall. A bottom of the base connects the inner wall and the outer wall forming the tray. The base may further include a rim edge parallel to the bottom and disposed annularly about the tray. The cover may include a circular bottom edge, and wherein the base further includes a rim wall surrounding the rim edge and substantially perpendicular to the rim edge, the rim wall and the rim edge cooperating with the bottom edge to retain the cover to the base. The grill may include a circular outer edge, the rim wall and the rim edge cooperating with the outer edge to retain the grill to the base. The grill includes a central opening that penetrates the grill with the opening aligned with the aperture in the base. The aperture is sized to accept a burner element of a gas stove.

The base may include one or more vent openings. The base includes a substantially flat bottom and may have vent openings that are elongated in a direction parallel to the flat bottom.

The invention also includes a method of using the described barbecue which includes steps of assembling the barbecue by placing the base over a burner of a gas stove and assembling the grill to the base by aligning the outer edge within the rim wall. A user then adds a fluid to the tray and places food to be cooked onto the grill, then assembles the cover to the base by aligning the bottom edge within the rim wall. Cooking starts when the user ignites the burner.

### BRIEF DESCRIPTION OF THE DRAWINGS

FIG. 1 is a perspective view of an embodiment of the barbecue of the invention, shown partially exploded to display internal structure.

FIG. 2 is a diagrammatic side sectional view of the embodiment of FIG. 1.

FIG. 3 is a diagrammatic side view of the base of the embodiment of FIG. 1.

FIG. 4 is a diagrammatic top view of the cover of the embodiment of FIG. 1.

FIG. 5 is a diagrammatic top view of the grill of the embodiment of FIG. 1.

### DETAILED DESCRIPTION OF THE INVENTION

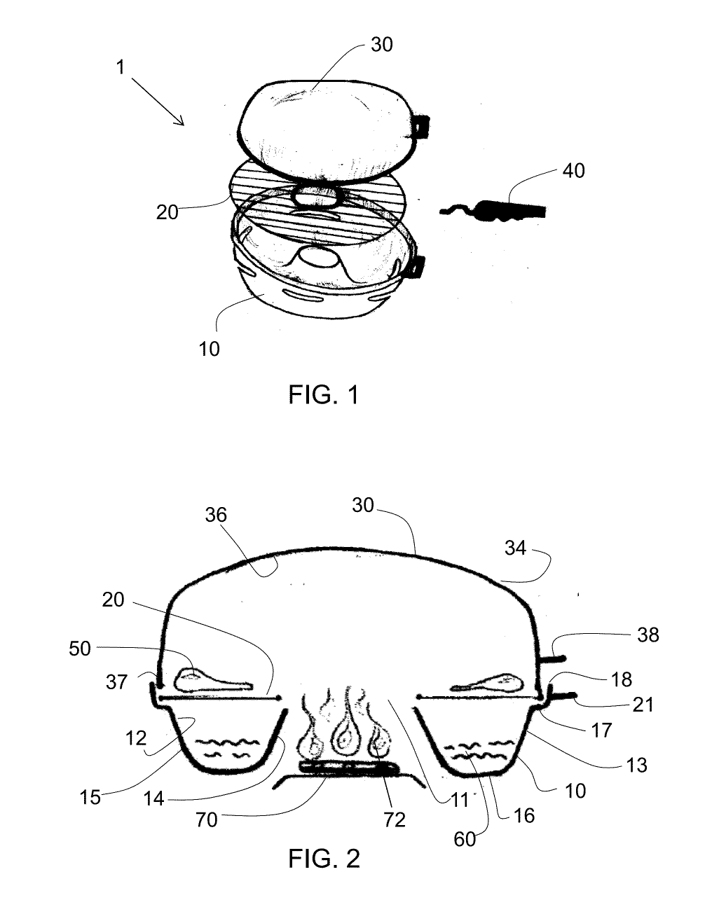

Referring to FIGS. 1 and 2, stove-top barbecue 1 includes base 10, grill 20, cover 30, and may also include removable handle 40. Base 10, grill 20, and cover 30 are sized and shaped to stack with grill 20 atop base 10 and cover 30 covering the combination of base 10 and grill 20. The assembled stack may be fully or partially unstacked for access to contents, for cleaning, or for storage. Barbecue 1 has working orientation with base 10 at the bottom.

The stacked base 10, grill 20, and cover 30 cooperate to form a partially-closed barbecue chamber. The chamber is partially closed because barbecue 1 includes an opening 11 on its underside (penetrating base 10 and the grill 20 but not penetrating cover 30). The assembled barbecue may be set with opening 11 over a gas burner element from a stove. Once the burner is turned on and fuel from the burner ignited, flames from the burner pass through opening 11 and heat the inside of barbecue 1 and its contents. Any food placed on grill 20 is cooked in this barbecue chamber by the combination of direct heat radiated by the flames, by conduction through heated barbecue components, and by the rapid convection caused by the flow of burning gases and subsequent heat transfer.

In some embodiments barbecue 1 is substantially circular when view from the top. This shape is beneficial because it helps to maximize heat transfer by convection from a centrally located stove burner. The circular shape also conforms to the shape of many common stove burner elements and is easy to clean and store. However, while the circular shape is beneficial, it should be understood that other shapes are also within the scope of the invention. For example, a more elongated barbecue unit might span the space between two stove burner elements and include two apertures so that it may receive heat from two burners. This would accommodate a larger amount of food.

Base 10 is best visible in FIGS. 1, 2, and 3 where like parts have corresponding reference numbers. Base 10 includes central aperture 11, generally concave inner surface 12, generally convex outer surface 13, inner wall 14, outer wall 15, bottom 16, ledge 17, rim wall 18, vents 19, and may include handle feature 21.

Base 10 (and cover 30) may be formed of a relatively thin, heat resistant material. A material is relatively thin if its thickness is much less than its maximum dimension. A suitable material is a strong metal such as steel to provide structural support, but applicant has found that embodiments can even be constructed of lightweight aluminum foils (such as are commercially available in “roasting pans” or chafer pans). Other suitable materials may include coated metals (such as anodized aluminum or steel with porcelain or with non-stick fluorocarbon coatings) and thermally conductive ceramics. In some embodiments, the several parts may have different compositions. Base 10 and cover 30 may be formed by any of a number of common processes, including dye casting, forging, or metal spinning.

Central aperture 11 is designed to allow barbecue 1 to fit over a stove-top burner and is sized accordingly. In some embodiments, aperture 11 is between about two inches and about five inches in diameter and the overall diameter of barbecue 1 is between about six inches and about fifteen inches.

Inner wall 14, outer wall 15, and bottom 16 form a toroidal tray disposed about aperture 11. This tray is designed to hold a liquid, usually water, that keeps the base from overheating and that absorbs smoke produced by the barbecue process. The tray also serves to capture any food drippings. I have found that filling the tray to a depth of from about one quarter of an inch to about two inches effectively reduces the amount of smoke produced by the barbecue so that its indoor use is practical. In some embodiments, a fill level of about one half of an inch to about one inch produces significant smoke reduction.

Base 10 also includes ledge 17 and rim wall 18, which together create a recess that helps locate and trap both grill 20 and cover 30. Ledge 17 may be a flange that is substantially parallel to bottom 16 with rim wall 18 projecting upwards from the outer edge of ledge 17. In other embodiments, ledge 17 may include a trough that extends circumferentially about the top of outer wall 15. The trough may be formed in a shape complementary to the periphery of grill 20 or of cover 30 or both.

In some embodiments (as illustrated in FIG. 2) grill 20 rests on ledge 17 and cover 30 in turn rests on grill 20. In other embodiments, ledge 17 may include features that directly support each of grill 20 and cover 30. Such features may be nested grooves or troughs at two different diameters, or they may include a single diameter feature with isolated supports that extend through openings of grill 20 to support cover 30.

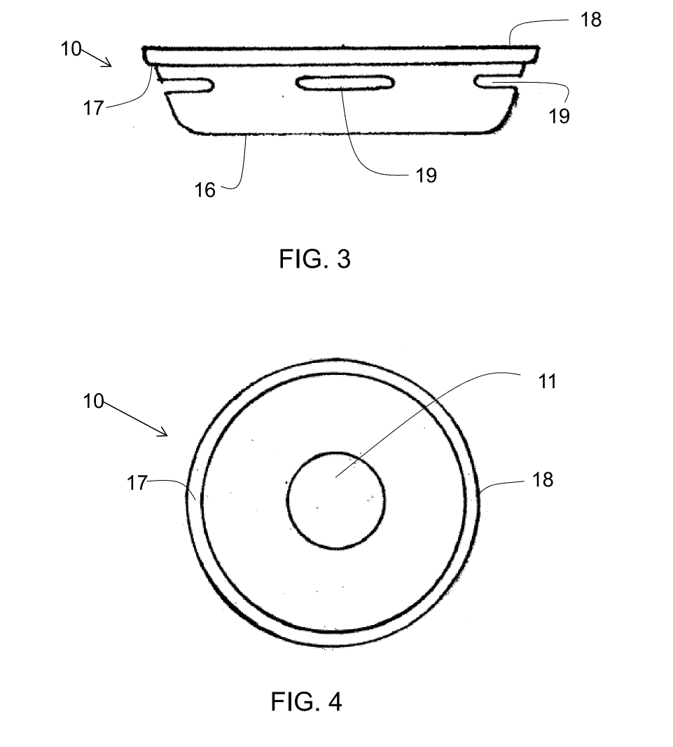

Base 10 also includes one or more vents 19 disposed in outer wall 15, best visible in FIG. 3. Vents 19 serve to allow escape of combustion products and other gases. Vents 19 may be elongated in the direction parallel to bottom 16 and are spaced towards the ledge 17 to allow the tray to receive liquid without spilling through vents 19. In some embodiments, there may be three to six vents 19.

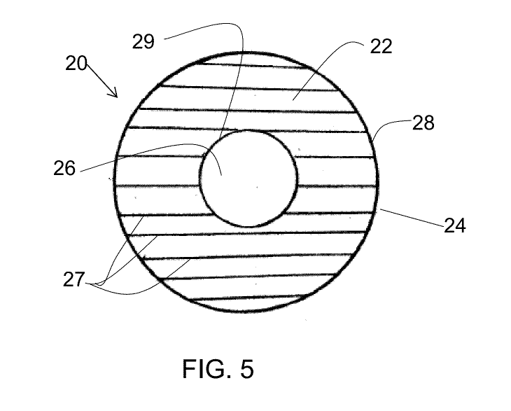

As best visible in FIGS. 1, 2, and 5, grill 20 includes cooking surface 22 with multiple openings to support food items and to permit free convection and exposure of food to heat. Cooking surface 22 is bounded by an outside edge 24 and a central hole 26. In some embodiments, grill 20 includes a plurality of metal wires 27 (three of which are labeled in FIG. 5) connected to a peripheral ring 28 and a central ring 29. Connection may be by welding, brazing, crimping, or similar process known in the art. Metal wires 27 may be plated or otherwise coated to reduce food sticking and simplify cleaning.

In other embodiments, grill 20 may include a pierced sheet of heat resistant material, such as plated, coated, or enameled steel. In still other embodiments, grill 20 may extend across aperture 11 without a central hole. This is possible in embodiments where grill 20 is sufficiently open that it will not significantly degrade the convection produced by flames traversing aperture 11. In such embodiments, the material of grill 20 must be selected to be resistant to direct application of flames from the burner 70.

Cover 30 includes generally concave inner surface 32, generally convex outer surface 34, bottom edge 37, and may include handle feature 38. The overall cross sectional shape may be a fairly smoothly curving dome above nearly vertical side portion as visible in FIG. 2. When viewed from above, the shape of cover 30 matched the outside shape of base 10 so that the two parts fit together to define the cooking space within the barbecue.

Bottom edge 37 is designed and configured to mate with base 10 as described above. In some embodiments, bottom edge 37 may be a raw or beaded edge. In other embodiments, bottom edge may include a flange or other feature to mate with base 10 at ledge 17. In still other embodiments, cover 30 may latch to base 10 such as by a bayonet style lock (not shown).

One purpose of cover 30 is to retain heat in barbecue 1. A second purpose is to contain smoke. A third purpose is to support convection driven by the flame in aperture 11. Combustion at burner 70 drives heated gases 72 upward into inner surface 32 of cover 30. The upper dome portion of cover 30 deflects the flow of hot gasses laterally until they collide peripherally with the side portion of inner surface 32. The side portion further deflected downward toward the food 50 on grill 20. This rapid and sustained flow of hot gasses rapidly cooks food 50. The flow of gases also serve to direct combustion products to the fluid in the tray of base 10, thereby helping to absorb smoke in the fluid.

Handle 40 may removable attach to either of base 10 or cover 30 so that the parts may more readily handled, particularly when hot. Handle 40 may attach to base 10 or cover 20 by any of a number of methods, including an interference fit between mating shapes, a cam or lever-actuated gripper, a magnetic fastener, or any other suitable method known in the art. Handle 40 may include an attachment portion for attaching as described above, and a grasping portion the user may hold. The grasping portion may be thermally insulated from the attachment portion to keep the grasping portion cool and avoid injury. Handle 40 when attached to cover 30 at handle feature 38 of cover 30 allows removal of cover 30. Handle 40 when attached at handle feature 21 of base 10 allows movement of base 10 and anything then supported by base 10, including entire barbecue 1.

In use, a user adds a smoke capture fluid such as water to the tray of base 10 and places base 10 about a burner on a gas stove. User places grill 20 in place, mating it with ledge 17 inside rim wall 18 of base 10 and arranges food on grill 20. User then assembles the cover to the base by aligning the bottom edge within the ledge 17 and inside rim wall 18. User then ignites burner 70 and adjust the flame to the desired intensity.

This specification discloses various aspects of the invention with reference to particular embodiments, but it should be understood that any of the features, functions, materials, or characteristics may be combined with any other of the described features, functions, materials, or characteristics. The description of particular features, functions, materials, or characteristics in connection with a particular embodiment is exemplary only; it should be understood that it is within the knowledge of one skilled in the art to include such feature, structure, or characteristic in connection with other embodiments whether or not explicitly described. I intend the scope of the appended claims to encompass such alternative embodiments. Variations on these described embodiments will become apparent to those of ordinary skill in the art upon reading the description. The inventor expects skilled artisans to employ such variations as appropriate, and the inventor intends for the invention to be practiced otherwise than specifically described herein. Accordingly, this specification and claims include all modifications and equivalents of the subject matter recited in the claims appended hereto as permitted by applicable law.

Unless otherwise indicated, all numbers used in the specification and claims are to be understood as being modified in all instances by the term “about.” Unless indicated to the contrary, the numerical values in the specification and attached claims are approximations that may vary depending upon the desired properties sought to be obtained.

The terms “a,” “an,” “the” and similar referents used in the context of describing the invention (especially in the context of the following claims) are intended to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the claims. No language in the specification should be construed as indicating any non-claimed element essential to the practice of the invention.

I claim:

1. A stove-top barbecue comprising:
a base including a central aperture, a concave tray surrounding the aperture, and a peripheral recess;
a cover configured to mount in the recess;
a grill sized to fit between the base and the cover, the grill including an open cooking surface
wherein the central aperture is sized to accept a burner element of a gas stove.

2. The barbecue of claim 1, wherein the grill includes a central hole, the hole positioned such that, when the grill is disposed on the base, the hole aligns with the aperture.

3. The barbecue of claim 1, wherein one or more of the cover and the base includes an attachment for a removable handle.

4. A stove-top barbecue comprising:
a base supporting a grill and a cover, wherein the base includes an aperture that penetrates the base and an annular tray surrounding the aperture, the tray configured to retain a fluid.

5. The barbecue of claim 4, wherein the base further includes an inner wall surrounding the aperture and a peripheral outer wall, the inner wall and the outer wall connected by a bottom, the inner wall, the outer wall, and the bottom forming the tray.

6. The barbecue of claim 5, wherein the base further includes a rim edge parallel to the bottom and disposed annularly about the tray.

7. The barbecue of claim 6, wherein the cover includes a circular bottom edge, and wherein the base further includes a rim wall surrounding the rim edge and substantially perpendicular to the rim edge, the rim wall and the rim edge cooperating with the bottom edge to retain the cover to the base.

8. The barbecue of claim 7, wherein the grill includes a circular outer edge, the rim wall and the rim edge cooperating with the outer edge to retain the grill to the base.

9. The barbecue of claim 4, wherein the grill includes a central opening that penetrates the grill, the opening aligned with the aperture.

10. The barbecue of claim 4, wherein aperture is sized to accept a burner element of a gas stove.

11. The barbecue of claim 4, wherein the base includes a plurality of vent openings.

12. The barbecue of claim 11, wherein the base includes a substantially flat bottom and wherein the vent openings are elongated to permit heating by flames from a burner on a stove.

13. A method of using the barbecue of claim 8, the method comprising:
placing the base over a burner of a gas stove;
adding a fluid to the tray;
assembling the grill to the base by aligning the outer edge within the rim wall;
disposing food to be cooked onto the grill;
assembling the cover to the base by aligning the bottom edge within the rim wall;
igniting the burner.
